(19) United States
(12) Patent Application Publication
(10) Pub. No.: US 2023/0380394 A1
(43) Pub. Date: Nov. 30, 2023

(54) Mechanism for Baiting Bags on a Trotline

(71) Applicant: Joel Denny, Centreville, MD (US)

(72) Inventor: Joel Denny, Centreville, MD (US)

(21) Appl. No.: 18/227,869

(22) Filed: Jul. 28, 2023

Related U.S. Application Data
(63) Continuation-in-part of application No. 17/519,467, filed on Nov. 4, 2021, now abandoned.

(51) Int. Cl. A01K 73/02; A01K 75/00

(52) U.S. Cl. CPC A01K 73/02; A01K 75/005

(57) ABSTRACT

A bag having an elongated body and opposite end portions is disclosed. The body has a sidewall that provides the body with a primary opening. The body has an interior region sized for containing crab bait inserted into the interior region via the primary opening. The interior region, bounded by the sidewall, includes a plurality of secondary openings that range from about 1 mm to about 10 mm for attracting at least one crab to the body to feed on the bait contained within the interior region. The body includes a slidably openable and closeable slide fastener which overlays the primary opening and is fixed to the sidewall between the body opposite end portions. The slide fastener, when open, enables bait to be inserted into the interior region and, when closed, retains bait within the interior region.

### REFERENCE TO RELATED APPLICATIONS

The present nonprovisional patent application is a continuation-in-part (“CIP”) of U.S. nonprovisional patent application Ser. No. 17/519,467 filed Nov. 4, 2021, which is based upon U.S. provisional patent application Ser. No. 63/230,579 filed Aug. 6, 2021, both hereby incorporated by reference in their entirety pursuant to 35 USC § 120.

### FIELD

The present subject matter is directed, in general, to the field of trotline crabbing. The present subject matter is directed, more particularly, to a trotline-crabbing mechanism which I developed to reduce the amount of time normally required by trotline crabbers to bait bags on their trotlines. The present subject matter is also directed to my bag design.

### BACKGROUND

In a crab fishery, it was common (about a hundred years ago) to use long lines, sometimes a mile or more in length, with ends attached to buoys moored in position by anchorages. At intervals along such a line were much shorter lines carrying the bait. The shorter lines would rest on the bottom of the crab fishery and crabbers would periodically start at one buoy and haul a boat along by the line to the other buoy, using a dip net along the way. This method was difficult to carry into proper effect by a single person since it was (and still is) very difficult, for a single person to pull on the line and properly use the dip net simultaneously, resulting in many crabs escaping capture. U.S. Pat. No. 1,777,783 to Burns et al. is directed to an automatic crab-catching device, said to solve this problem.

U.S. Pat. No. 2,599,113 to Latta et al. discloses a trotline setter mechanism adapted and configured for attachment to a boat gunwale and designed for use in trotline fishing. U.S. Pat. No. 3,419,990 to Lewis et al. is directed to a fishing apparatus having a pair of intermeshing gears mounted on a base for drawing a trotline out of water for re-baiting and removing fish caught on hooks of the “trots” (or droplines) of a mainline of the trotline.

U.S. Pat. No. 3,775,894 to Goddard discloses an apparatus for attaching hooks to a trotline and for setting a trotline. U.S. Pat. No. 4,685,243 to Pugh discloses a trotline reel and hook holder that prevents entanglement of hooks and stores hooks in an orderly fashion.

A trotline is a simple system consisting of a line of heavier-grade cord which can be manufactured from preselected woven fibers which, in the past, have typically been cotton fibers but at the present time are often synthetic or polymeric fibers. There are many, like myself, who use trotlines to catch crabs. “Trotline crabbers,” as we are called, often attach 400-700 bags, each containing 3-6 clams, at spaced intervals along a trotline.

While there is no mention of a trotline in the following prior art, U.S. Pat. No. 5,497,582 to Kuhn discloses a crabbing bait holder frame including a pair of joined planar members adapted to hold bait in position therebetween. The planar members include openings and locking tab lengths along the top, bottom, and side edges of the frame to secure the planar members together. The frame is raised or lowered into water by a dropline to support the weight of one or more crabs holding onto the frame while eating bait inside. US published application 2006/0042146 to Waddy, Jr. et al. discloses a fishing lure including a bag formed of open mesh material closed at one end, open at the opposite end, and having a drawstring for drawing the open end closed, for retaining a portion of a fishhook placed within the bag and a leader attached to the fishhook and extending through the open end.

U.S. Pat. No. 6,848,210 to Altman et al. is directed to a biodegradable container for holding and distributing chum. The container, biodegradable for avoiding environmental and aesthetic pollution, includes a plurality of perforations through its sidewalls to attract fish. U.S. Pat. No. 7,490,432 to Gillihan discloses a bait bag-and-hook combination that includes a bag mounted on a hook in such a way that the bag does not prevent impaling game fish. The bag includes an easy-opening and re-closing apparatus which efficiently re-fills a bag. Moreover, bags are said to be manufactured of material durable enough to withstand the underwater environment yet permeable enough to release the scent of bait contained within. US published application 2018/0242566 to Hutchinson is directed to containers for dispensing bait in variable amounts and at variable rates. Configurations of two attachable sleeves are changed, with different configurations resulting in different overlapping of openings in attachable sleeves. Diverse opening overlap allows fishermen a flexibility to better control dispensing of bait and/or chum by varying size of an opening.

US published application 2019/0029243 to Troshinsky discloses a chum delivery device having a body including a plurality of openings through its sidewall, at least one open end, at least one removable cap, and one or more hook attachments. The plural openings through the sidewall of the body are configured to allow chum within the body to be released and the removable caps are configured to seal the open ends of the body. US published application 2021/0274765 to Troshinsky discloses what US 2019/0029243 does but further discloses a chum delivery system that includes a plurality of depressions configured for insertion of chum and a chum delivery device that has a plurality of holes.

For principles of trotline crabbing, see U.S. Pat. No. 5,157,858 to Lockner et al., which is prior art, hereby incorporated by reference in its entirety. A crab line roller mechanism 10, attached to and outwardly extending from an upper surface 16 of a boat 12, is used to raise and guide a trotline 18 in a body of water 14. The trotline 18 (FIG. 1), depicting trotline crabbing as practiced by a trotline crabber 17 of at least a generation ago, shows bait 20 attached to trotline 18. At that time, the bait 20 would have been decaying chicken or eel. (Current trotline crabbers use clams, within bags secured to their trotlines, as bait.) The bait 20 lures a submerged crab 15 which begins feeding. The trotline 18 is next raised to the surface of the water 14, enabling the crabber 17 to catch the crab 15 with a net 19. While current trotline crabbers often work from a larger boat and use equipment more sophisticated than what is shown in FIG. 1, their crab-catching efficiency is restricted by the time needed to bait their trotlines, a “problem” that the present subject matter solves.

For the present subject matter, the term “bag” shall refer to a bag, sack, pouch, or other container of predetermined size having at least one opening sized to admit crab bait into the bag. The opening is closeable to retain crab bait within the bag. Such bags can be made of natural materials (e.g., cotton) or synthetic materials (e.g., nylon, polyester). Sides of the bags include much smaller openings to attract crabs to bait contained within.

Current trotline crabbers may use a trotline of about 3,000-4,000 feet in length (with 3,600-foot lengths being common). As a result, trotline crabbers may have about 400 to 700 bags (or about 500 to 600 bags) removably attached to their trotlines, at appropriately spaced intervals. Current trotline crabbers may use mesh bags open at one end with sidewalls made of such materials as polyethylene, polypropylene, polyurethane, nylon, or rayon. Crabbing trotlines are currently re-baited as follows. When a length of trotline with an attached plurality of crab-baited bags is deemed to contain “spent” bait requiring re-baiting each bag, it takes a professional crabber about 3-5 hours or more to manually re-bait each bag on a single trotline. Reducing the amount of time required by a trotline crabber to do so, would free-up a crabber to use a trotline to catch crabs, for sale. Throughout this patent specification, the term “spent” crab bait shall be understood to refer to bait, drawn through so much water while fixed to a trotline to enable a trotline crabber to catch crabs drawn to the bait, that the bait no longer serves as a crab attractant.

The present subject matter solves problems inherent in the design of plastic mesh bags that are currently favored by trotline crabbers. Most mesh bags, elongated sleeves of polymeric mesh material (e.g., nylon), are closed at one end and open at the opposite end. Conventional bag design requires a trotline crabber to first load a mesh bag with fresh bait, and thereafter dispose of spent bait from each mesh bag which had been on the trotline. Since each spent bait bag is manually removed from a trotline, and thereafter manually re-attached (after fresh bait is substituted for spent bait), a significant amount of time is spent by trotline crabbers removing each bag from a trotline and re-attaching each bag now filled with “fresh” bait to the trotline. The present subject matter solves the current problems associated with the removal and re-attachment of bait bags to trotlines.

### SUMMARY

Briefly summarizing this aspect of the present subject matter, the bag, secured to a trotline and sized and configured to contain crab bait, includes an elongated body and a slide fastener. The bag body includes opposite end portions and a sidewall. The body includes an interior region dimensioned to contain crab bait (3-6 clams) within the body.

The bag sidewall includes a primary opening oriented between the opposed bag end portions. In embodiments, the sidewall includes plural secondary openings of a size and configuration that spans merely releasing the scent of crab bait contained within to permitting a portion of the crab bait within the interior region to extend through at least one of the secondary openings to attract at least one crab to the sidewall to feed on bait contained within. In other embodiments, the secondary openings are as described in the detailed description. When a bag is fixed (e.g., at one end portion) to a trotline, the slide fastener, secured to the sidewall, is openable and/or closeable over the primary opening.

Refilling a bag of my present design thus does not require removal from a trotline.

While a zipper is well known and a preferred slide fastener, the present subject matter extends to the broader term “slide fastener,” a mechanism comprising two parallel tracks of teeth or coils that are inter-lockable or separable by pulling a slide between them.

Additional aspects and features of the present subject matter-solving various problems not solved by the prior art reviewed above—shall become clear to a person or ordinary skill in the art (“POSITA”) after reviewing the detailed description which follows.

### BRIEF DESCRIPTION OF THE DRAWING FIGURES

FIG. 1, identified as “prior art,” presents an illustrative example of trotline crabbing.

FIG. 2, identified as “prior art,” shows a conventional trotline crabber netting a crab.

FIGS. 3 and 4, identified as prior art, are “snapshots” depicting the conventional trotline crabber re-loading a conventional bait bag following conventional process steps.

FIG. 5, identified as prior art, is a “snapshot” presenting a knot formed in a trotline.

FIG. 6, also “prior art,” depicts a side elevational view of a conventional bait bag.

FIG. 7 presents a side elevational view of a bait bag of the present subject matter.

FIGS. 8 and 9, each a “bird's-eye-view,” show a person using a mechanism of the present subject matter to re-load a plurality of bait bags of the present subject matter.

FIG. 10 is a front elevational view of the mechanism of the present subject matter.

FIGS. 11, 12 are front and back elevational views, respectively, of the mechanism.

FIG. 13 is an elevational view of the mechanism shown in FIG. 10, from the right.

FIG. 14 depicts a motor-providing component for a mechanism shown in FIG. 10.

FIG. 15 presents a feature of a component of the mechanism depicted in FIG. 14.

FIG. 16 shows an alternative view of an on/off control mechanism operatively connected to the mechanism depicted in FIG. 10.

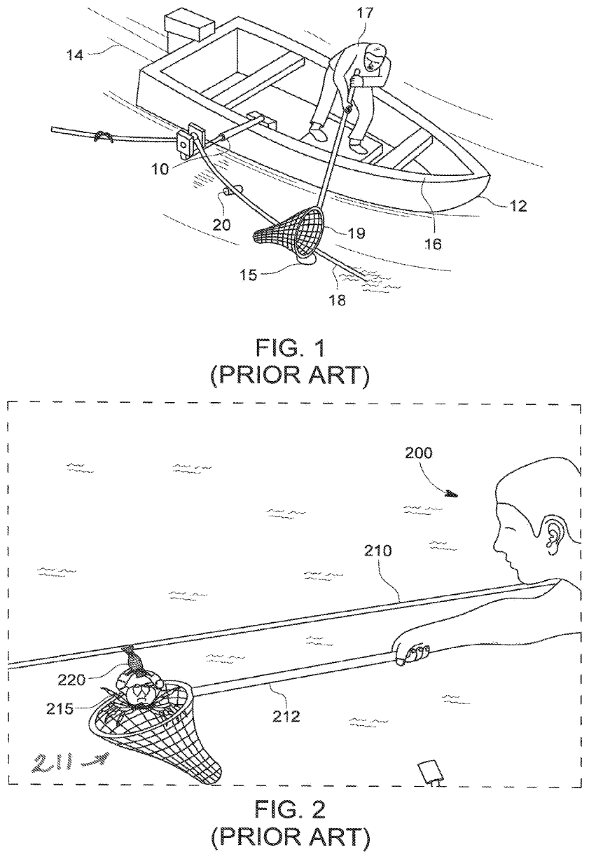

Throughout the drawing figures and detailed description (which follows), I shall use similar reference numerals to refer to similar components of the present subject matter.

### DETAILED DESCRIPTION

Before describing the present subject matter-my invention—in detail, I want to provide a few visual images regarding current trotline crabbing practice, for enabling a person of ordinary skill in the art (“POSITA”) reading this patent specification to better understand why my bag design and mechanism for re-baiting trotlines will be viewed by many commercial trotline crabbers as much-needed, time-saving articles of manufacture.

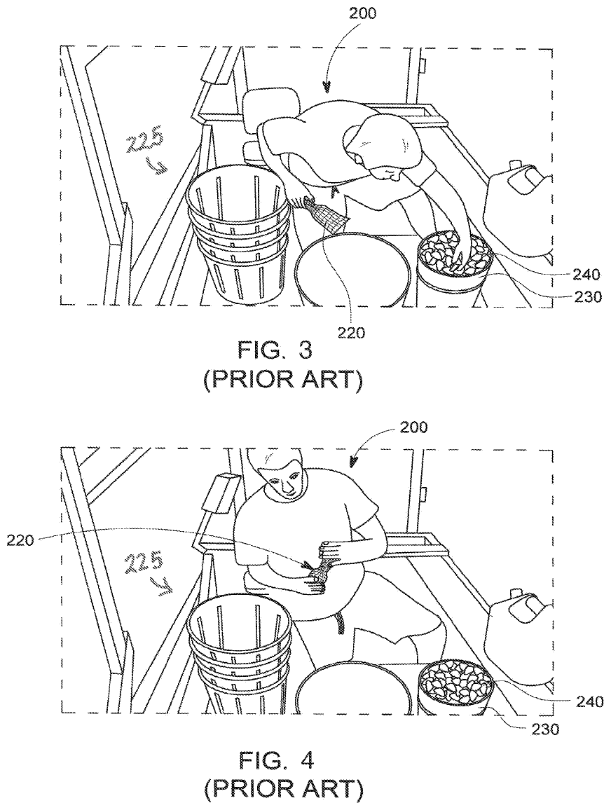

In FIG. 2, a trotline crabber 200 uses a conventional trotline 210 and conventional bag 220 attached to the trotline 210 to catch a crab 215. Crabber 200 uses a net 211 attached to a handle 212 to catch the crab 215 (which is shown attached to the bag 220). FIG. 3 shows a trotline crabber 200 reaching into a bucket 230 to grasp with his/her left palm a handful of (e.g., 3-6) clams 240 which are to be transferred into a conventional bag 200 held in his/her right palm while seated on a conventional trotline-crabbing boat 225. FIG. 4 shows trotline crabber 200 after having inserted the clams into the bag 220.

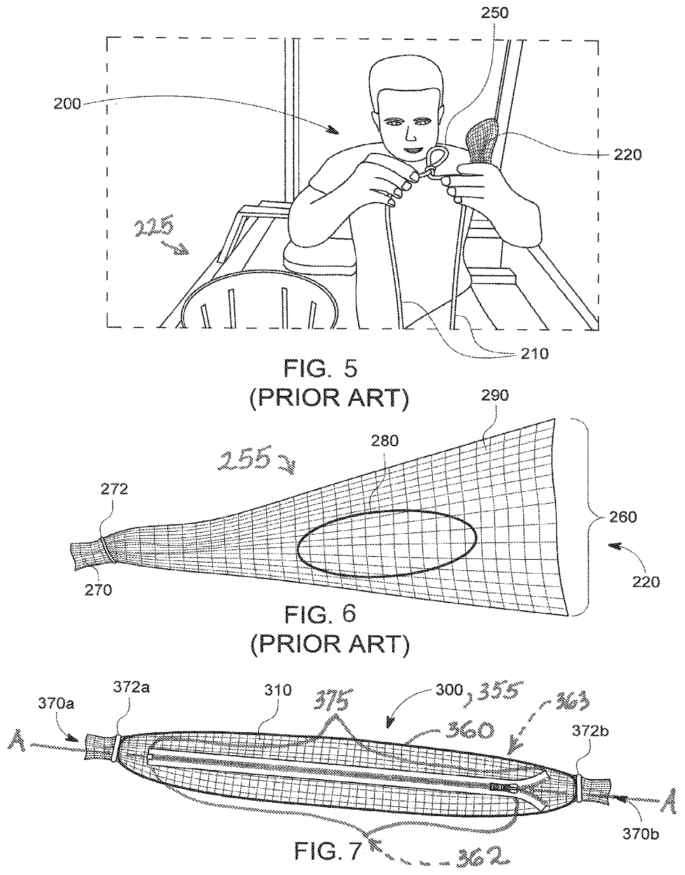

FIG. 5 depicts the trotline crabber 200 displaying a special knot 250 formed in the trotline 210 for removably securing a conventional bag 220 to a trotline 210. FIG. 6 depicts a conventional bag 220 consisting of an elongated body 255 having opposite end portions. Body 255 includes a sidewall 290 having a primary opening 260 at one end portion and an opposite end portion (at end 270) closed by a clasp 272. The sidewall 290 includes a plurality of secondary openings 280 (many of which are shown encircled). The secondary openings 280 are defined by a mesh barrier structure. (The term “mesh” as used throughout this patent specification shall be understood to mean a barrier made of connected strands manufactured from fiber or from other flexible or ductile materials.) The entire sidewall 290 of a conventional bag 220 is essentially a mesh barrier structure. In operation, a trotline crabber 200 forms a knot 250 according to a known procedure for securely closing the opening 260 —after a bag 200 has been re-loaded with “fresh” crab bait—for securing a bag 220 to the trotline 210. The knot 250 allows a trotline crabber 200 to easily remove a bag 220 containing “spent” bait from the trotline 210 when desired.

FIG. 7 presents an embodiment of a bag 300 of the present subject matter. Bag 300 has an elongated body 355, shaped as a sleeve, with opposite end portions 370a and 370b, each of which is respectively closed by a clasp 372a and 372b. The body 355 includes a sidewall 360 defining a primary opening 362 longitudinally oriented along an axis A-A and dimensioned for inserting crab bait (e.g., 3-6 clams) into the body 355. (The primary opening 362 is hidden behind a slide fastener 375.) The body 355 defines an interior region 363 for receiving crab bait inserted through the primary opening 362 into the body 355. The interior region 363 is bounded by the sidewall 360. The sidewall 360 includes a plurality of secondary openings 310 which are defined by a mesh barrier structure. Secondary openings 310 each range from about 3 millimeters (“mm”) to about 8 mm for attracting at least one crab to the sidewall 360 to feed on crab bait in bag 300.

The body 355 includes a slidably openable and closeable slide fastener 375 (overlaying the primary opening 362) and fixed (e.g., stitched) to the sidewall 360 between the opposite end portions 370a, 370b. (Primary opening 362 is hidden by slide fastener 375.) The slide fastener 375, when open, enables crab bait to be inserted into the interior region 363 and, when closed, securely retains the crab bait within the interior region 363.

In embodiments, sidewall 360 can be manufactured from a variety of fiber-based materials or from assorted flexible or ductile materials which include but are not limited to a material that is selected from the group consisting of aramid fiber, cotton, high-density polyethylene (“HOPE”), nylon (e.g., “nylon 6, 6”), polyethylene, polyurethane, and rayon.

In embodiments, a bag 300 can have a generally cylindrical body 355 and can be shaped as an elongated sleeve of nylon mesh and having secondary openings 310 that range from about 1 millimeter (“mm”) to about 10 mm (or about 3 mm to about 8 mm or about 4 mm to about 7 mm). In embodiments, the slide fastener 375 can be a zipper. In embodiments, the bag 300 can be releasably secured to a trotline 210 by a releasable knot, such as the knot 250, skillfully formed at spaced-apart intervals along a trotline 210.

The slide fastener 375 is fixed to the sidewall 360 to overlay the primary opening 362 for enabling a person (e.g., a trotline crabber) to open a bag 300 to remove “spent” bait and, thereafter, re-load the bag 300 with “fresh” bait. Later, when fresh bait eventually becomes “spent,” meaning that such bait is no longer able to attract a crab to the bag 300 (secured to trotline 210), the slide fastener 375 enables a person to open the bag 300 for discarding the “spent” bait and, thereafter, again “re-loading” the bag 300 with “fresh” bait.

Utility of the present invention will become clear after reading how my bag design significantly reduces amount-of-time a trotline crabber must devote to re-baiting a trotline.

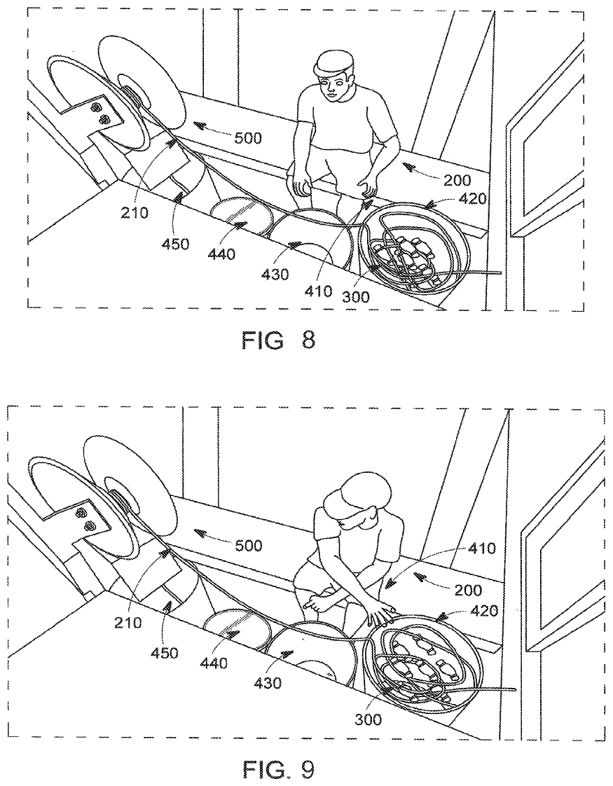

FIGS. 8 and 9 exemplify a time-saving feature of the present subject matter. For example, instead of needing to remove a plurality of conventional bags 220 from a trotline 210—to replace “spent” crab bait with “fresh” bait—a trotline crabber 200 now only needs to use the slide fastener 375 on each bag 300 (of the present subject matter), to reload each such bag 300 with “fresh” bait without ever removing a single bag 300 from a trotline 210. Instead of interrupting a crabber 200 (ordinarily trotline crabbing on a boat) for purposes of “re-loading” bags (containing “spent” crab bait) with “fresh” bait, as shown in FIG. 5, a trotline baiting mechanism 500 of the present subject matter is portable and, thus, can be located anywhere, such as an “off-boat” location shown in FIGS. 8 and 9.

The mechanism 500 of the present invention, which is portable, can be located on a boat or elsewhere. For instance, there is shown in FIGS. 8 and 9 an elongated horizontal surface or bench 410 on which a person such as a trotline crabber 200 can sit. Adjacent to the horizontal surface or bench 410 is a first bucket 420 containing a plurality of bags 300 of the present subject matter, each bag removably secured to a trotline 210.

In accordance with the present subject matter, only a bag 300 that has become damaged while in “crabbing” use will need to be removed from a trotline 210 and replaced.

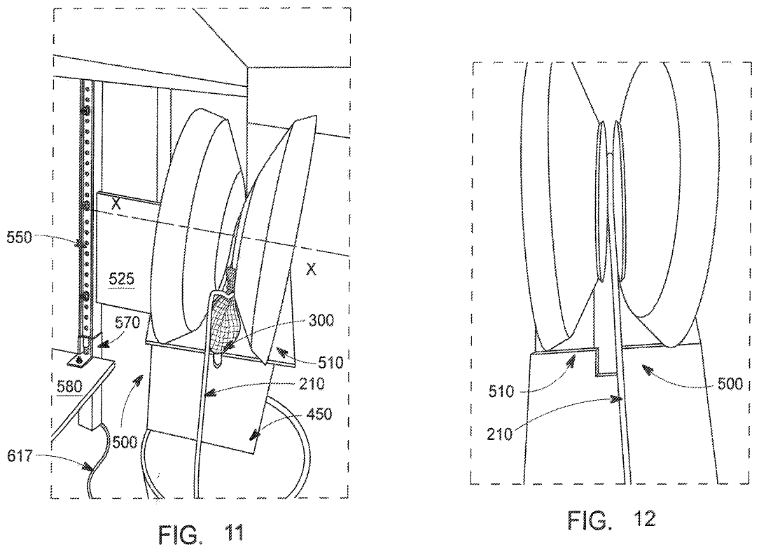

While seated, a person such as trotline crabber 200 can reach into first bucket 420 with one hand as shown in FIG. 9 to fetch a bag 300 secured to trotline 210, zip-open a fetched bag 300, discard “spent” bait into a second bucket or container 430, fetch from a third bucket or container 440 “fresh” bait, add the fresh bait into a zipped-open bag 300, zip-close a fresh-bait filled bag 300, and use a pedal apparatus 611 (FIG. 6) associated with the reel mechanism 500, for purposes of advancing a plurality of the fresh-bait filled bags 300 secured to a trotline 210, into a fourth bucket or receptacle 450 (FIGS. 9, 11).

A plurality of bags 300 (please see FIGS. 8 and 9) are removably secured to the trotline 210 at intervals (along the trotline 210) that are spaced (preferably equally) from the two nearest bags 300 (of the plural bags 300) which are on the trotline 210.

Furthermore, while each bag 300 (FIG. 7) can be removably secured to the trotline 210 via a knot 250 (as shown in FIG. 5), a person of ordinary skill in the art (“POSITA”) may know about retainers such as an assortment of snap hooks disclosed in U.S. Pat. No. 4,464,813 to Bakker et al. (hereby incorporated by reference in its entirety) for removably securing bags 300 to a trotline 210, if removal of bags 300 from trotline 210 is necessary.

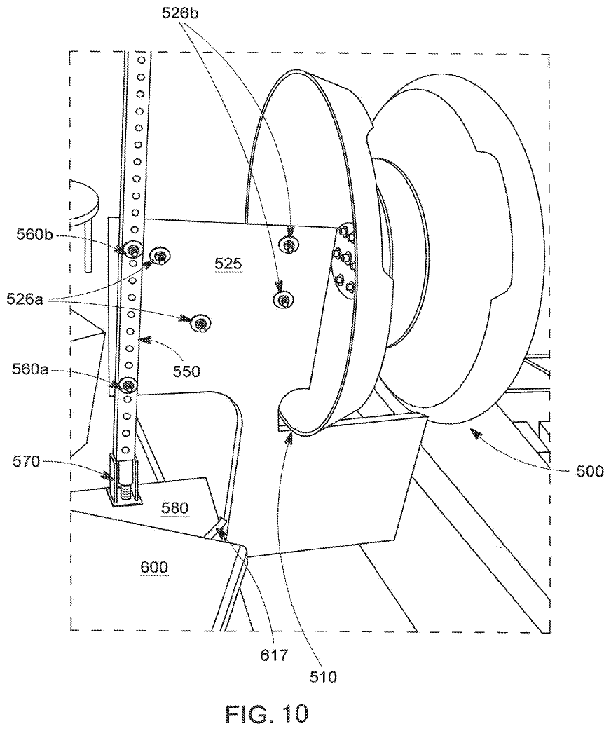

Please see FIGS. 10, 11, 12, 13, 14, 15 for a detailed description of a prototype of a trotline baiting mechanism 500 designed to be used with a predetermined length of trotline 210 to which the plural bags 300 are removably secured at spaced-apart intervals.

The mechanism 500 includes a reel 510 rotatable about an axis X-X (FIG. 11) for transferring the bags 300 (secured to trotline 210 at spaced-apart regions) from a first region, e.g., first bucket 420 (FIGS. 8,9), to a second region, e.g., fourth bucket 450.

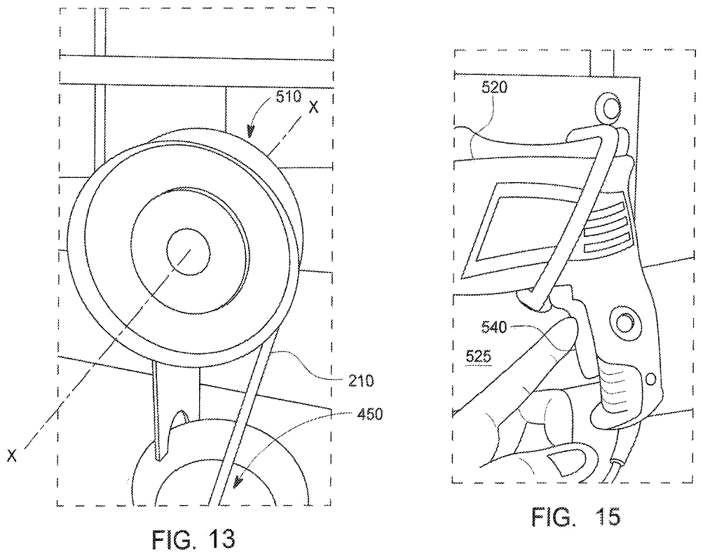

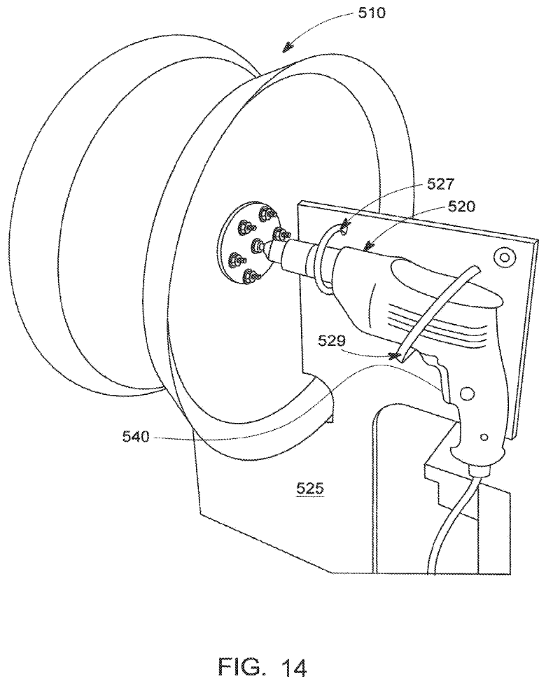

A reel mechanism 500 of the present subject matter includes a conventional motor for powering rotation of the reel 510 about the axis X-X (FIG. 13). One such motor can, e.g., be the motor of a conventional hand-held drill 520 (FIG. 14). The drill 520 is secured by a pair of brackets 527, 529 to a surface of a planar support structure 525 by suitably sized threaded-fastener components 526a and 526b (FIG. 10). The brackets 527, 529 themselves are sized and arranged about the hand-held drill 520 for securely retaining the drill 520 while also allowing unrestrained rotation of the reel 510 about the axis X-X.

Drill 520, a component of reel mechanism 500, has a trigger 540 (FIG. 15) for adjusting and thus “setting” a preferred rotational speed for reel 510 about the axis X-X.

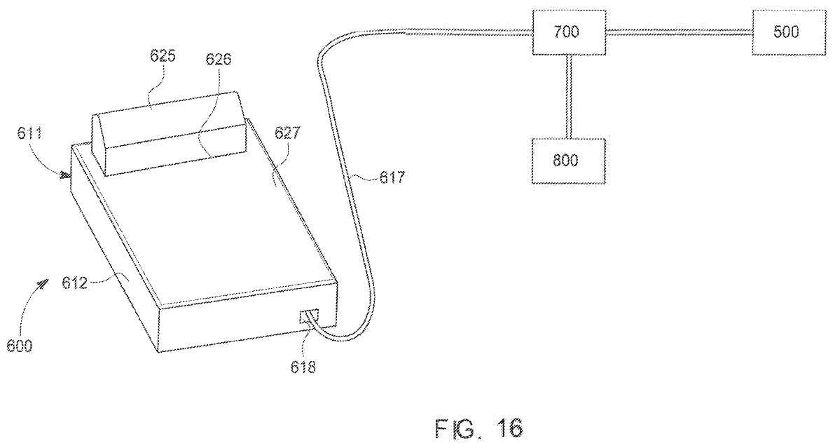

Additionally, an on/off control mechanism 600 (FIG. 16) is operatively connected to the reel mechanism 500 (FIG. 10) by a power cable 617 and a control system 700. The on/off control mechanism 600 includes a foot-pedal apparatus 611 consisting of a partially hollow base 612, a spring-biased foot pedal 625 partially depressible along an edge margin 626 into the base 612 for starting and/or stopping rotation of the reel 510 about the axis X-X (FIG. 11), and a relatively flat upper surface 627 for a person such as a trotline crabber 200 to rest his/her foot when engaging the foot pedal 625. In operation, depression of the foot pedal 625 into the base 612 starts rotation of reel 510 about axis X-X and (again) depressing the foot pedal 625 into the base 612 stops rotation of the reel 510 about axis X-X. A power system 800 provides power to the control system 700, which operatively connects the reel mechanism 500 to the on/off mechanism 600. Power cable 617 extends from control system 700 into a cable inlet 618 formed within base 612.

The reel mechanism 500 of the illustrated embodiment of the present subject matter includes a vertically oriented mounting bar 550 (FIG. 10) to which the planar support structure 525 is held firmly in place by a pair of conventional threaded-fastener components 560a, 560b. The mounting bar 550 is securely held in place by a clamp 570 secured to a worktable 580 by jaws (of the clamp 570) fixed to the underside of table 580.

Operation of the reel mechanism 500 of the present subject matter thus enables a person sitting on a bench 410 (as shown in FIGS. 8 and 9) to reach into a first bucket 420 to fetch a bag 300 containing spent crab bait on a trotline 210 and then use a slide fastener 375 (as shown in FIG. 7) to open the bag 300, remove spent bait, re-load the bag 300 with fresh bait, and use slide fastener 375 to close the fresh bait-loaded bag 300, next transfer fresh bait-loaded bags 300 to another bucket 450 (see, e.g., FIGS. 9, 11) and then use an on/off control mechanism 600 (shown in FIG. 16) until another bag 300 on trotline 210 is close enough to the person to repeat the process steps just described.

A person of ordinary skill in the art (“POSITA”) is aware that the control system 700, the disclosed components of reel mechanism 500, and the disclosed components of on/off control mechanism 600 are all modifiable for enabling the embodiments of the reel mechanism 500 and/or the control mechanism 600 disclosed herein to be fully portable.

Accordingly, when the reel mechanism 500 is operated by a person in a manner to achieve the process steps described above, the reel mechanism 500 can very easily be used by a person of ordinary skill in the art (“POSITA”) of trotline crabbing, for substituting fresh bait for spent bait present in plural bags 300, located at spaced-apart intervals along a length of a trotline 210, much faster than can be done at the present time. Moreover, since the reel mechanism 500 is not required to be on a trotline crabbing vessel, a trotline crabber (currently on such a vessel) is free to engage in trotline crabbing.

Illustrated and described throughout this patent specification is a mechanism developed to reduce amount of time required by trotline crabbers to bait bags on a trotline. The present subject matter is also directed to a novel bag design trotline crabbers will find useful. While the present subject matter has been described in connection with exemplary embodiments, the present subject matter is not limited to the embodiments disclosed. On the contrary, numerous alternatives, changes, and/or modifications will become apparent to a person of ordinary skill in the prior art (“POSITA”) after this patent specification has been reviewed in connection with its drawing figures. Therefore, all such alternatives, changes, and/or modifications are to be interpreted as forming a part of the present subject matter insofar as they fall within the spirit and scope of the appended claims.

I claim:

1. A bag removably secured to a trotline, comprising:
an elongated body having opposite end portions and a sidewall, wherein the body defines an interior region bounded by the sidewall, wherein the sidewall defines:
a primary opening dimensioned for inserting crab bait into the body, wherein the primary opening is located between the opposed end portions, and
a plurality of secondary openings dimensioned for attracting at least one crab to the interior region for purposes of feeding on the crab bait in the bag, and
a slidably openable and closeable slide fastener overlaying the primary opening and secured to the sidewall between the opposite end portions, wherein the slide fastener when open enables crab bait to be inserted into the interior region, and wherein the slide fastener when closed retains the crab bait in the interior region.

2. The bag of claim 1, wherein the sidewall is made of a material selected from the group consisting of aramid fiber, cotton, HDPE, nylon, polyethylene, polyurethane, and rayon.

3. The bag of claim 1, wherein the bag is a nylon mesh bag.

4. The bag of claim 3, wherein the secondary openings range from about 1 mm to 10 mm.

5. The bag of claim 4, wherein the slide fastener is a zipper, and wherein the bag is removably secured to the trotline by a preselected, removable knot formed in the trotline.

6. A trotline-baiting mechanism for use with a predetermined length of trotline having a plurality of bags secured thereto at spaced-apart intervals along the length, comprising:
a reel rotatable about an axis for causing portions of the trotline and the plurality of trotline-secured bags to be transferred from a first location to a second location;
a motor for powering rotation of the reel about the axis; and
an on/off mechanism configured for providing a user with on/off control of the motor.

7. The trotline-baiting mechanism of claim 6, wherein the on/off mechanism is configured for enabling a user to engage a pedal adapted for causing the motor to power off and on.

8. The trotline-baiting mechanism of claim 6, wherein a motor of a hand-held drill is used to power rotation of the reel about the axis, wherein the mechanism includes a stand for rotatably mounting the reel for rotation about the axis, wherein the stand includes a surface portion, and wherein the drill is removably secured to the surface portion.

9. The trotline-baiting mechanism of claim 8, wherein the hand-held drill includes a trigger mechanism for controlling rotational speed of the reel about the axis.

10. The trotline baiting mechanism of claim 6, wherein at least one bag of the plurality of bags comprises:
an elongated body having opposite end portions and a sidewall, wherein the body defines an interior region bounded by the sidewall, wherein the sidewall defines:
a primary opening dimensioned for inserting crab bait into the body, wherein the primary opening is located between the opposed end portions, and
a plurality of secondary openings dimensioned for attracting at least one crab to the interior region for purposes of feeding on the crab bait in the bag, and
a slidably openable and closeable slide fastener overlaying the primary opening and secured to the sidewall between the opposite end portions, wherein the slide fastener when open enables crab bait to be inserted into the interior region, and wherein the slide fastener when closed retains the crab bait in the interior region.

11. The trotline baiting mechanism of claim 10, wherein the sidewall is made of a material selected from the group consisting of aramid fiber, cotton, HDPE, nylon, polyethylene, polyurethane, and rayon.

12. The trotline baiting mechanism of claim 10, wherein the at least one bag is a nylon mesh bag.

13. The trotline baiting mechanism of claim 12, wherein the secondary openings range from about 1 mm to about 10 mm.

14. The trotline baiting mechanism of claim 13, wherein the slide fastener is a zipper, and wherein the at least one bag is removably secured to the trotline by a preselected, removable knot formed in the trotline.
